(19) United States
(12) Patent Application Publication
(10) Pub. No.: US 2022/0360351 A1
(43) Pub. Date: Nov. 10, 2022

(54) Timeslot Assignment Method for Power Line Communication and Apparatus

(71) Applicant: Huawei Technologies Co., Ltd., Shenzhen (CN)

(72) Inventors: Wenchao Cai, Wuhan (CN); Yan Zeng, Dongguan (CN)

(21) Appl. No.: 17/814,397

(22) Filed: Jul. 22, 2022

Related U.S. Application Data
(63) Continuation of application No. PCT/CN2021/072710, filed on Jan. 19, 2021.

(30) Foreign Application Priority Data
Jan. 23, 2020 (CN) 202010076048.6

(51) Int. Cl. H04J 3/16; H04B 3/54

(52) U.S. Cl. CPC H04J 3/1682; H04B 3/544

(57) ABSTRACT

A first relay node receives a first timeslot assignment message sent by an upper-level node, where the first timeslot assignment message includes forwarding information and first timeslot information, and the forwarding information includes a forwarding indication indicating that at least one relay node needs to forward the first timeslot assignment message. The first relay node updates the first timeslot information to obtain second timeslot information, where the updating includes deleting an expired timeslot indication from the first timeslot information. The first relay node sends a second timeslot assignment message including the forwarding information and the second timeslot information.

### CROSS-REFERENCE TO RELATED APPLICATIONS

This application is continuation of International Application No. PCT/CN2021/072710, filed on Jan. 19, 2021, which claims priority to Chinese Patent Application No. 202010076048.6, filed on Jan. 23, 2020 . The disclosures of the aforementioned applications are hereby incorporated by reference in their entireties.

### TECHNICAL FIELD

This application relates to the field of power line communication, and in particular, to a timeslot assignment method for power line communication and an apparatus.

### BACKGROUND

In an application scenario of power line communication (PLC), there is a requirement for long-distance and multi-level relaying. For example, light control is performed through PLC in airfield ground lighting. A maximum of a power line on a runway reaches several kilometers, and a maximum of a single-hop communication distance in PLC is about 1.2 km. Therefore, remote light control can be implemented only through multi-level relaying. For example, street lamps are controlled through PLC. Because the street lights extend over a very long distance, control information needs to be forwarded by relay nodes, to implement unified control of the street lamps.

Based on the feature of the multi-level relaying, a message such as a control message sent by a head node needs to be forwarded by a plurality of relay nodes before reaching an end node. In this case, a delay of receiving the message by the end node is relatively long. In an existing solution, sufficient time is reserved for each relay node to forward the message, and consequently efficiency of this message forwarding mode is definitely low.

### SUMMARY

Embodiments of this application provide a timeslot assignment method for power line communication, an apparatus, and a system. Forwarding efficiency of a relay node can be greatly improved.

According to a first aspect, an embodiment of this application provides a timeslot assignment method for power line communication, applied to a multi-level power line communications network, where the multi-level power line communications network includes at least one head node, each head node is directly or indirectly connected to at least one relay node, cascading of a plurality of relay nodes may be considered as a plurality of levels, one of the at least one relay node (which may be referred to as a first relay node) is used as a representative for description, and the method includes:

The first relay node receives a first timeslot assignment message sent by an upper-level node, where the first timeslot assignment message includes forwarding information and first timeslot information; and the forwarding information includes a forwarding indication indicating that the at least one relay node needs to forward the first timeslot assignment message, and the first timeslot information includes a forwarding timeslot indication assigned to the at least one relay node and used to forward the first timeslot assignment message, and data timeslot indications assigned to a plurality of nodes and used to send service data.

The first relay node updates the first timeslot information to obtain second timeslot information, where the updating includes deleting an expired timeslot indication from the first timeslot information, the expired timeslot indication is a timeslot indication indicating that an indicated timeslot has expired, and the second timeslot information includes a data timeslot indication of at least one node that is used to send service data.

The first relay node sends a second timeslot assignment message including the forwarding information and the second timeslot information.

By using the solution in this embodiment, each relay node may delete an expired timeslot before forwarding timeslot indication information. This saves transmission resources, and prevents another node from discarding the received timeslot indication information after discovering, through parsing, that the timeslot indication information expires, to improve processing efficiency.

In a possible implementation, the updating further includes deleting a timeslot indication assigned to the first relay node from the first timeslot information, and the timeslot indication assigned to the first relay node includes a forwarding timeslot of the first relay node, or a forwarding timeslot and a data timeslot of the first relay node.

In a possible implementation, the updating further includes adjusting at least one timeslot indication that is not deleted, and the adjusting includes prolonging or shortening a timeslot.

In a possible implementation, forwarding information in the second timeslot assignment message includes a forwarding indication indicating that the at least one relay node needs to forward the second timeslot assignment message, and the second timeslot information includes a forwarding timeslot indication assigned to the at least one relay node and used to forward the second timeslot assignment message.

By using the solution of this embodiment, each relay node may flexibly adjust, based on a requirement, timeslot indication information sent to a downstream node. This avoids a problem in the conventional technology that a latest requirement cannot be met because a head node defines that timeslots are all assigned in advance without considering a subsequent transmission parameter change or the like.

In a possible implementation, timeslots separately indicated by a forwarding timeslot indication and a data timeslot indication of at least one relay node that are included in the first timeslot information are adjacent.

In a possible implementation, the first relay node may further add timeslot indication information of a new node. In this manner, an upper-level relay node may not need to set timeslot indications of excessive nodes in advance, but indicates only timeslot indications of nodes at the first lower level or the first two lower levels, and timeslot indications of nodes at a lower level may be added layer by layer by upper-level relay nodes of the nodes. In this way, a timeslot indication can be more flexible, and an actual assignment time point is closer to an assigned timeslot. This can avoid expiration, and can better meet a latest timeslot requirement.

According to a second aspect, an embodiment of this application provides an access point, including a slot processing unit and a transceiver unit.

The transceiver unit receives a first timeslot assignment message sent by an upper-level node, where the first timeslot assignment message includes forwarding information and first timeslot information; the forwarding information includes a forwarding indication indicating that at least one relay node needs to forward the first timeslot assignment message, and the first timeslot information includes a forwarding timeslot indication assigned to the at least one relay node and used to forward the first timeslot assignment message, and data timeslot indications assigned to a plurality of nodes and used to send service data; and the plurality of nodes include the at least one relay node, and the at least one relay node includes a first relay node.

The timeslot processing unit is configured to update the first timeslot information to obtain second timeslot information, where the updating includes deleting an expired timeslot indication from the first timeslot information, the expired timeslot indication is a timeslot indication indicating that an indicated timeslot has expired, and the second timeslot information includes a data timeslot indication of at least one node that is used to send service data.

The transceiver unit is further configured to send a second timeslot assignment message including the forwarding information and the second timeslot information.

In a possible implementation, the updating includes deleting a timeslot indication assigned to the first relay node from the first timeslot information, and the timeslot indication assigned to the first relay node includes a forwarding timeslot of the first relay node, or a forwarding timeslot and a data timeslot of the first relay node.

In a possible implementation, the updating includes adjusting at least one timeslot indication that is not deleted, and the adjusting includes prolonging or shortening a timeslot.

In a possible implementation, forwarding information in the second timeslot assignment message includes a forwarding indication indicating that the at least one relay node needs to forward the second timeslot assignment message, and the second timeslot information includes a forwarding timeslot indication assigned to the at least one relay node and used to forward the second timeslot assignment message.

In a possible implementation, timeslots separately indicated by a forwarding timeslot indication and a data timeslot indication of at least one relay node that are included in the first timeslot information are adjacent.

According to a third aspect, an embodiment of this application provides an access point, including a processor and a transceiver. When the access point is run, the processor executes computer instructions, so that the access point performs the method according to the first aspect.

In a possible implementation, the apparatus further includes a memory. The memory is configured to store the foregoing computer instructions.

According to a fourth aspect, an embodiment of this application provides a power line communications network, including at least one head node, where each head node is at least directly or indirectly connected to one or more relay nodes, and the relay node is the foregoing access point.

### BRIEF DESCRIPTION OF THE DRAWINGS

FIG. 1 is a schematic diagram of a topology of PLC multi-level relaying;

FIG. 2 is a flowchart of a timeslot assignment method for power line communication according to an embodiment of the present invention;

FIG. 3 is another flowchart of a timeslot assignment method for power line communication according to an embodiment of the present invention;

FIG. 4 is a schematic diagram of timeslot assignment according to an embodiment of the present invention;

FIG. 5 is another schematic diagram of timeslot assignment according to an embodiment of the present invention;

FIG. 6 is a schematic diagram of a structure of an access point according to an embodiment of this application; and

FIG. 7 is a schematic diagram of a structure of another access point according to an embodiment of this application.

### DETAILED DESCRIPTION OF ILLUSTRATIVE EMBODIMENTS

In this specification, the claims, and the accompanying drawings of this application, terms “first”, “second”, “third”, “fourth”, and the like (if existent) are intended to distinguish between similar objects but do not necessarily indicate a specific order or sequence. It should be understood that the data termed in such a way are interchangeable in proper circumstances so that embodiments of this application described herein can be implemented in orders except the order illustrated or described herein. Moreover, terms “include”, “contain” and any other variants thereof mean to cover the non-exclusive inclusion. For example, a process, a method, a system, a product, or a device that includes a list of steps or units is not necessarily limited to those expressly listed steps or units, but may include other steps or units not expressly listed or inherent to such the process, the method, the product, or the device.

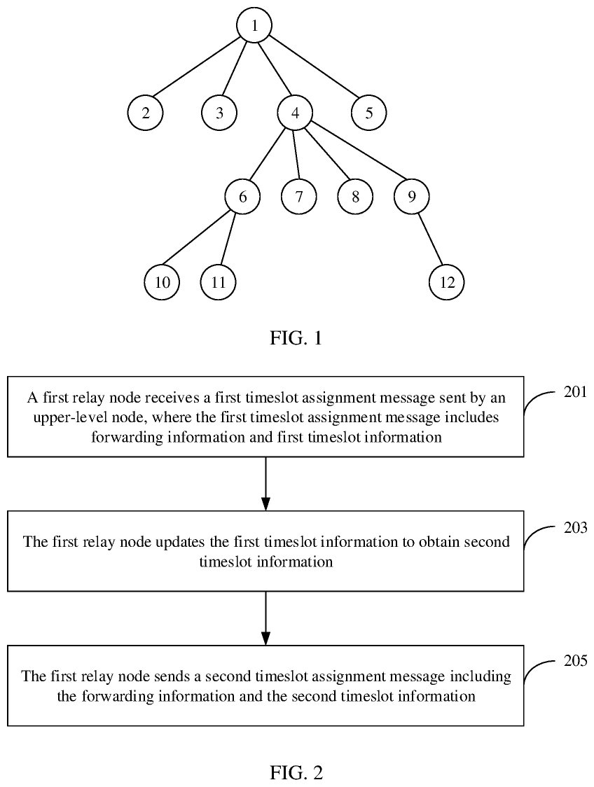

A PLC network, also referred to as a carrier communications network, is a communications network that uses low-voltage power lines as communications media to aggregate, transmit, and exchange power consumption information of low-voltage electric power users, and mainly adopts an orthogonal frequency division multiplexing technology. PLC with 1 MHz or below 1 MHz is generally referred to as narrowband PLC, PLC with a band ranging from 2 MHz to 12 MHz is referred to as mid-band PLC, and PLC with a band ranging from 2 MHz to 80 MHz is referred to as broadband PLC. As shown in FIG. 1, a PLC network generally includes a head node, a relay node, and a slave node. The head node is a central coordinator (CCO), and serves as a master node in the network to be responsible for completing functions such as networking control and network maintenance and management. A device entity corresponding to the head node is a concentrator local communications unit. The relay node is a proxy coordinator (PCO), is a station configured to perform data relaying and forwarding between the central coordinator and a station or between stations, and is also referred to as a proxy node. The slave node is a common station (STA), and serves as a slave node in the communications network. A device entity corresponding to the slave node is a communications unit, and includes an electricity meter carrier module, an I-type collector carrier module, an II-type collector, or the like. In this specification, the head node, the master node, and the central coordinator are a same concept, and for ease of description, are referred to as a CCO for short below. The relay node, the proxy node, and the proxy coordinator are a same concept, and for ease of description, are referred to as a PCO for short below.

FIG. 1 is a schematic diagram of a topology of PLC multi-level relaying. In the figure, a node 1 is a CCO, nodes 4, 6, and 9 are PCOs, and other nodes are STAs. FIG. 1 is merely an example. It should be understood that other levels may include one or more PCOs than the first level at which the CCO is located and the last level at which an end node is located. Because each node generally broadcasts a message, only a node whose distance (that is, a length of a circuit connecting various nodes) from each node falls within a specific range can receive a broadcast message. A node that cannot receive the broadcast message can only receive the message forwarded by an upper-level PCO of the node. Certainly, each node may alternatively unicast a message, that is, a target node is indicated in a sent header. The two types of messages can be received by a node whose distance from each node falls within a specific range. A difference lies in that a node receiving the broadcast message parses a header and a payload, but a node receiving the unicast message discards the message and does not parse a payload after parsing the header and finding that the message is not sent to the node.

A message sending mechanism of the CCO, the PCO, and the slave node is time division multiplexing. Timeslots in which the CCO, the PCO, and the slave node can send messages are generally all assigned by the CCO. An assigned unit period includes timeslots in which the COO and each PCO send beacon packets and timeslots in which all nodes send service data. For ease of description, the timeslot in which the PCO sends the beacon packet is referred to as a forwarding timeslot for short below, and the timeslot in which each node sends the service data is referred to as a data timeslot for short below. The forwarded beacon packet is used to indicate timeslot assignment information. Generally, the CCO broadcasts a beacon packet to notify another node of a timeslot of the another node. Because the beacon packet broadcast by the CCO cannot directly reach a node far away from the CCO, a PCO that can receive the beacon packet forwards the beacon packet to the node far away from the CCO. The PCO forwards the beacon packet based on a timeslot assigned to the PCO in the received beacon packet. In the conventional technology, in one unit period, all forwarding timeslots are set before all data timeslots, and before forwarding a beacon packet, a PCO basically does not modify other content than some fields such as a destination node identifier. In this way, all forwarding actions need to be completed, that is, all nodes start to transmit service data only after receiving timeslots indicated by beacon packets. Even if some nodes have received the timeslots indicated by the beacon packets, the nodes can start to send service data only after a last-hop PCO completes forwarding and enters a data timeslot, causing a relatively long delay. Consequently, a large quantity of nodes wait for a long time, and node communication efficiency is very low.

An embodiment of the present invention provides a timeslot assignment method for power line communication, as shown in FIG. 2, including the following.

Step 201: A first relay node receives a first timeslot assignment message sent by an upper-level node, where the first timeslot assignment message includes forwarding information and first timeslot information; the forwarding information includes a forwarding indication indicating that at least one relay node needs to forward the first timeslot assignment message, and the first timeslot information includes a forwarding timeslot indication assigned to the at least one relay node and used to forward the first timeslot assignment message, and data timeslot indications assigned to a plurality of nodes and used to send service data; and the plurality of nodes include the at least one relay node, and the at least one relay node includes the first relay node.

Step 203: The first relay node updates the first timeslot information to obtain second timeslot information, where the updating includes deleting an expired timeslot indication from the first timeslot information, the expired timeslot indication is a timeslot indication indicating that an indicated timeslot has expired, and the second timeslot information includes a data timeslot indication of at least one node that is used to send service data.

Specifically, the first relay node parses the received first timeslot assignment message, identifies a timeslot indicated by each timeslot indication in the first timeslot information, and considers, based on a local clock, a timeslot that is before a current moment of the local clock as an expired timeslot. An expired timeslot indicates a time period that has passed, and has no actual meaning.

Step 205: The first relay node sends a second timeslot assignment message including the forwarding information and the second timeslot information.

By using the solution in this embodiment, each relay node may delete an expired timeslot before forwarding timeslot indication information. This saves transmission resources, and prevents another node from discarding the received timeslot indication information after discovering, through parsing, that the timeslot indication information expires, to improve processing efficiency.

The sending manner is broadcasting. The first timeslot assignment message and the second timeslot assignment message may be beacon packets defined in the ITU-T G.hn standard or MAP messages defined in the IEEE 1901.1 standard.

In an optional embodiment, the updating in step 205 includes deleting a timeslot indication assigned to the first relay node from the first timeslot information, and the timeslot indication assigned to the first relay node includes a forwarding timeslot of the first relay node, or a forwarding timeslot and a data timeslot of the first relay node.

In another optional embodiment, the first relay node may adjust at least one timeslot indication that is not deleted, and the adjusting includes prolonging or shortening a timeslot.

By using the solution of this embodiment, each relay node may flexibly adjust, based on a requirement, timeslot indication information sent to a downstream node. This avoids a problem in the conventional technology that a latest timeslot requirement cannot be met because a head node defines that timeslots are all assigned in advance without considering a subsequent transmission parameter change or the like.

In still another optional embodiment, the first relay node may further add timeslot indication information of a new node. In this manner, an upper-level relay node may not need to set timeslot indications of excessive nodes in advance, but indicates only timeslot indications of nodes at the first lower level or the first two lower levels, and timeslot indications of nodes at a lower level may be added layer by layer by upper-level relay nodes of the nodes. In this way, a timeslot indication can be more flexible, and an actual assignment time point is closer to an assigned timeslot. This can avoid expiration, and can better meet a latest timeslot requirement.

In still another optional embodiment, forwarding information in the second timeslot assignment message includes a forwarding indication indicating that the at least one relay node needs to forward the second timeslot assignment message, and the second timeslot information includes a forwarding timeslot indication assigned to the at least one relay node and used to forward the second timeslot assignment message.

In still another optional embodiment, timeslots separately indicated by a forwarding timeslot indication and a data timeslot indication of at least one PCO that are included in the first timeslot information are adjacent. To be specific, a data timeslot of a same PCO is after a forwarding timeslot of the PCO, and there is no gap between the two timeslots, or there is a gap but the gap is not assigned to another node. In this way, after completing forwarding, the PCO may directly send data without waiting for another node, so that data processing efficiency is improved.

As an optional feature, each of the data timeslots that are assigned to the plurality of nodes for sending the service data may be a data timeslot exclusively occupied by each node, or may be a data timeslot that can be shared by all nodes, or some nodes have exclusive timeslots, but some nodes need to preempt shared data timeslots.

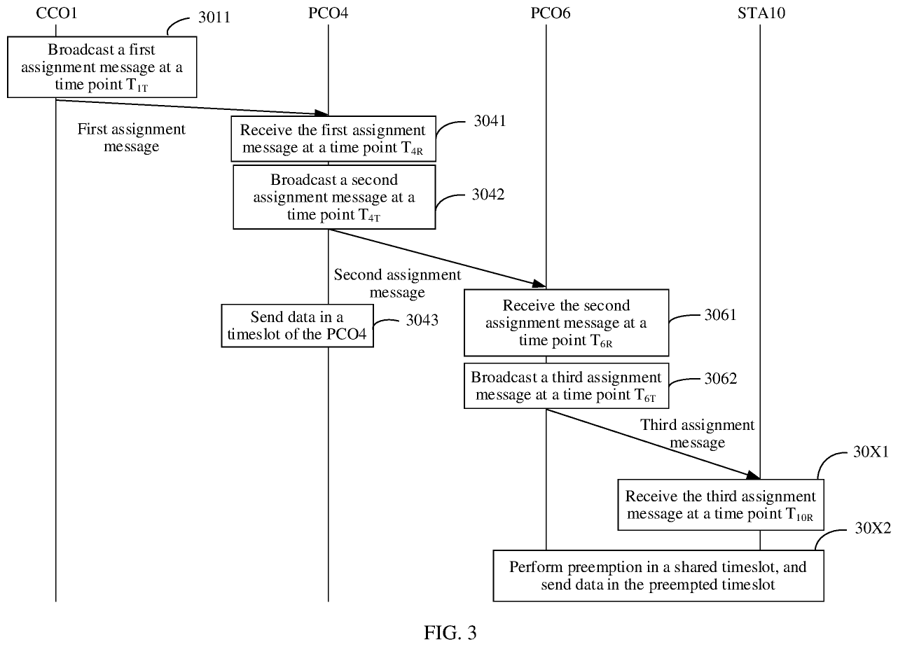

The following provides detailed description with reference to the network shown in FIG. 1. Refer to FIG. 3.

Step 3011: A node 1 serving as a CCO is marked as CCO1, constructs a first timeslot assignment message, and broadcasts the first timeslot assignment message at a time point T_{1T}, where the first timeslot assignment message includes forwarding information and first timeslot information, the forwarding information is used to indicate that all PCOs in a network need to forward the first timeslot assignment message, and the first timeslot information is used to indicate a forwarding timeslot assigned to each PCO and a data timeslot assigned to each PCO and each STA.

Step 3041: A node 4 serving as the PCO is marked as PCO4, receives the first timeslot assignment message at a time point T_{4R}, and then updates the first timeslot information in the first timeslot assignment message to obtain second timeslot information, where the updating includes deleting an expired timeslot indication from the first timeslot information, and optionally adjusting an unexpired timeslot indication. Details are described below.

Step 3042: PCO4 broadcasts a second timeslot assignment message including the forwarding information and the second timeslot information at a time point T_{4T} in the forwarding timeslot assigned to PCO4.

Step 3043: If the data timeslot assigned to PCO4 is after the forwarding timeslot of PCO4, the PCO sends service data in the data timeslot of the PCO.

PCO6 is also a relay node, and processing of PCO6 is similar to that of PCO4.

Step 3061: PCO6 receives the second timeslot assignment message at a time point

T_{6R}, and then updates the second timeslot information in the second timeslot assignment message to obtain third timeslot information, where the updating includes deleting an expired timeslot indication from the second timeslot information, and optionally adjusting an unexpired timeslot indication.

Step 3062: PCO6 broadcasts the third timeslot assignment message including the forwarding information and the third timeslot information at a time point T_{6T} in the forwarding timeslot assigned to PCO6.

Step 30X1: A node lo serving as an ordinary station is marked as STA10, and receives the third timeslot assignment message at a moment T_{10R}.

Step 30X2: If there is a shared timeslot assigned to all nodes (including an ordinary station and a relay node) after T_{10R}, STA10 performs timeslot preemption, and if at least a part of the timeslot is preempted, STA10 sends service data in the preempted timeslot. If the preemption fails, STAR) waits for another data timeslot indication. If there is a timeslot assigned exclusively to STAio after T_{10R}, STA10 sends service data in the timeslot.

It should be noted that, nodes 2, 3, 5, 7, 8, 11, and 12 are also ordinary stations and can receive the timeslot assignment message broadcast by CCO1, PCO4, or PCO6; and the nodes send service data based on data timeslot indications assigned to the nodes in the message. Processing is similar to that of STA10. FIG. 3 does not show processing steps of the nodes. Certainly, each of data timeslots assigned to the nodes may be a timeslot exclusively occupied by a specific node, or may be a timeslot shared by a plurality of nodes but needs to be preempted.

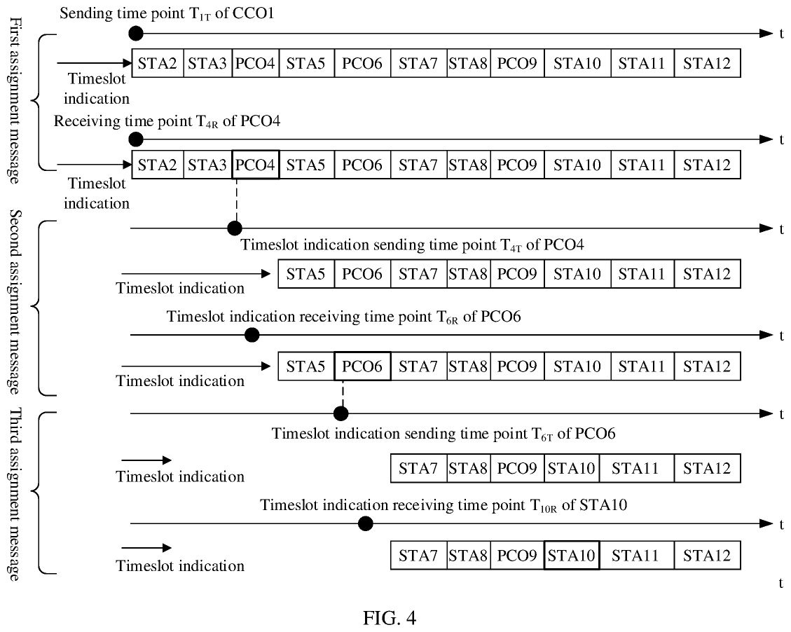

The following describes timeslot indication adjustment in FIG. 3 with reference to FIG. 4. As shown in FIG. 4, a first timeslot assignment message broadcast by node 1 at a time point T_{1T} includes a forwarding indication indicating that node 4, node 6, and node 9 need to forward the first timeslot assignment message, and exclusive timeslot information of each of nodes 2 to 12. The timeslot information of node 4, node 6, and node 9 includes forwarding timeslot information and data timeslot information, and the timeslot information of nodes 2, 3, 5, 7, 8, 10, 11, and 12 includes only data timeslot information.

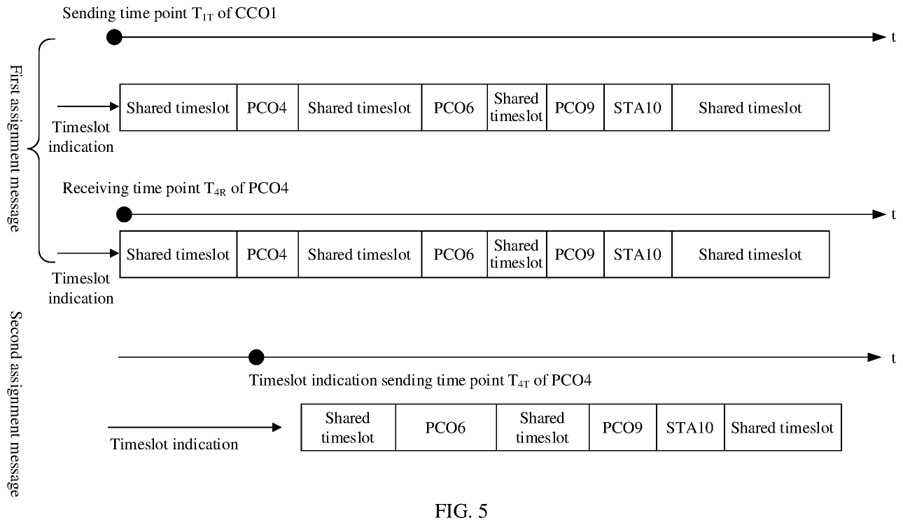

Node 4 receives the first timeslot assignment message at a time point T_{4R}. Because the time point T_{4R} is earlier than a timeslot assigned to node 4, node 4 needs to wait for the timeslot of node 4 before forwarding the timeslot assignment message and sending service data. In addition, when reaching a forwarding timeslot of node 4, timeslots assigned to nodes 2 and 3 expire, and node 4 needs to delete the timeslots. Node 4 further deletes a timeslot indication of node 4 to obtain new timeslot information, and then broadcasts the forwarding indication of the first timeslot assignment message and the new timeslot information as a second timeslot assignment message. As shown in FIG. 4, compared with the first timeslot assignment message, the current second timeslot assignment message does not include the forwarding indication of node 4 and the timeslot information of nodes 2 to 4. A sending time point T_{4T} is in the forwarding timeslot of node 4. Although in this scenario, each node has an exclusive timeslot, it may be understood that an expired shared timeslot is processed in a similar manner. As shown in FIG. 5, node 4 deletes the first expired timeslot and a timeslot of node 4, and adjusts a subsequent timeslot based on a requirement to obtain new timeslot information. In FIG. 5, timeslots marked as PCO4, PCO6, PCO9, or STA10 are separately timeslots exclusively occupied by nodes 4, 6, 9, and 10, and timeslots marked as shared timeslots are timeslots that can be preempted by all nodes.

Node 6 receives the second timeslot assignment message at a time point T_{6R} Because the time point T_{6R} is earlier than a timeslot assigned to node 6, node 6 also needs to wait for the timeslot of node 6 before forwarding the timeslot assignment message and sending service data. In addition, when reaching a forwarding timeslot of node 6, the timeslot assigned to node 4 expires, and node 6 needs to delete the timeslot. Node 6 further deletes a timeslot indication of the node 6, and, based on a requirement, prolongs a timeslot of node 10 and shortens a timeslot of node 11 to obtain new timeslot information, and then broadcasts the forwarding indication of the second timeslot assignment message and the new timeslot information as a third timeslot assignment message. As shown in FIG. 4, compared with the second timeslot assignment message, the current third timeslot assignment message does not include the forwarding indication of node 4 and the timeslot information of nodes 2 and 3. A sending time point T_{6T} is in the forwarding timeslot of node 6. Node 6 may determine, based on a condition such as a historical data busy degree or channel quality of another node, whether to adjust a length of a timeslot of the another node. In an optional manner, if there is another node after node 12, node 6 further extends a time axis to indicate another timeslot when obtaining the new timeslot information.

Node 10 receives the third timeslot assignment message at a time piont T_{10R}, and sends service data in a data timeslot assigned to node 10 in the third timeslot assignment message.

In a PLC network, a node receives a plurality of timeslot assignment messages at different time points, and forwards the timeslot assignment message or sends service data based on a timeslot indication in the timeslot assignment message as long as receiving the message is received. If a timeslot indicated by a previous received timeslot assignment message has not been reached, a new timeslot assignment message is received, and a timeslot indicated by the new timeslot assignment message is earlier than the timeslot indicated by the previous timeslot assignment message, the node first forwards the timeslot assignment message or sends service data in the timeslot indicated by the new timeslot assignment message. If the timeslot indicated by the subsequently received new timeslot assignment message is later than the timeslot indicated by the previous timeslot assignment message, the node first forwards the timeslot assignment message or sends service data in the timeslot indicated by the previous timeslot assignment message.

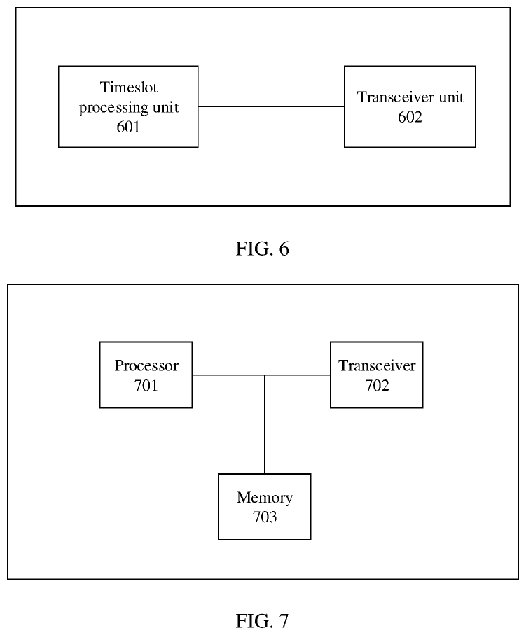

Refer to FIG. 6. An embodiment of this application provides an access point. The access point may include a timeslot processing unit 610 and a transceiver unit 620.

The transceiver unit 620 is configured to receive a first timeslot assignment message sent by an upper-level node, where the first timeslot assignment message includes forwarding information and first timeslot information; the forwarding information includes a forwarding indication indicating that at least one relay node needs to forward the first timeslot assignment message, the first timeslot information includes a forwarding timeslot indication assigned to the at least one relay node and used to forward the first timeslot assignment message, and data timeslot indications assigned to a plurality of nodes and used to send service data; and the plurality of nodes include the at least one relay node, and the at least one relay node includes a first relay node.

The timeslot processing unit 610 is configured to update the first timeslot information to obtain second timeslot information, where the updating includes deleting an expired timeslot indication from the first timeslot information, the expired timeslot indication is a timeslot indication indicating that an indicated timeslot has expired, and the second timeslot information includes a data timeslot indication of at least one node that is used to send service data.

The transceiver unit 620 is further configured to send a second timeslot assignment message including the forwarding information and the second timeslot information.

The sending manner is broadcasting. The first timeslot assignment message and the second timeslot assignment message may be beacon packets or MAP messages.

The updating further includes deleting a timeslot indication assigned to the first relay node from the first timeslot information, and the timeslot indication assigned to the first relay node includes a forwarding timeslot of the first relay node, or a forwarding timeslot and a data timeslot of the first relay node.

The timeslot processing unit 610 may adjust at least one timeslot indication that is not deleted, and the adjusting includes prolonging or shortening a timeslot.

Forwarding information in the second timeslot assignment message includes a forwarding indication indicating that the at least one relay node needs to forward the second timeslot assignment message, and the second timeslot information includes a forwarding timeslot indication assigned to the at least one relay node and used to forward the second timeslot assignment message.

Timeslots separately indicated by a forwarding timeslot indication and a data timeslot indication of at least one PCO that are included in the first timeslot information are adjacent.

The access point may be any node other than the head node in FIG. 3. A processing manner of the nodes in the embodiment corresponding to FIG. 3 should be jointly completed by the timeslot processing unit 610 and the transceiver unit 620. For details, refer to the content corresponding to FIG. 3.

Refer to FIG. 7. An embodiment of this application provides an access point. The access point may include a processor 710 and a transceiver 720. When the access point is run, the processor 710 executes computer instructions, so that the access point performs the method shown in FIG. 2. The optional embodiment corresponding to FIG. 2 is also applicable to the access point in this embodiment. Details are not described again.

In some embodiments, as shown in FIG. 7, the apparatus further includes a memory 730. The memory 730 may be configured to store the foregoing computer instructions and the like.

An embodiment of this application further provides a power line communications network, including at least one head node. Each head node is directly or indirectly connected to at least one relay node, and the relay node is the access point shown in FIG. 6 or FIG. 7.

It may be understood that, the processor in embodiments of this application may be a central processing unit (CPU), the processor may further be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any conventional processor.

The method steps in embodiments of this application may be implemented in a hardware manner, or may be implemented in a manner of executing software instructions by the processor. The software instructions may include corresponding software modules. The software modules may be stored in a random access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a CD-ROM, or any other form of storage medium well-known in the art. For example, a storage medium is coupled to a processor, so that the processor can read information from the storage medium or write information into the storage medium. Certainly, the storage medium may be further a component of the processor. The processor and the storage medium may be located in an ASIC.

All or some of embodiments may be implemented by using software, hardware, firmware, or any combination thereof. When software is used to implement the embodiments, all or a part of the embodiments may be implemented in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted by using the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

Finally, it should be noted that the foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method, comprising:
receiving, by a first relay node, a first timeslot assignment message sent by an upper-level node, wherein the first timeslot assignment message comprises forwarding information and first timeslot information, the forwarding information comprises a forwarding indication indicating that at least one relay node needs to forward the first timeslot assignment message, and the first timeslot information comprises at least one forwarding timeslot indication assigned to the at least one relay node for forwarding the first timeslot assignment message, and further comprises data timeslot indications assigned to a plurality of nodes for sending service data, and wherein the plurality of nodes comprise the at least one relay node, and the at least one relay node comprises the first relay node;
updating, by the first relay node, the first timeslot information to obtain second timeslot information, wherein updating the first timeslot information comprises deleting an expired timeslot indication from the first timeslot information, wherein the expired timeslot indication is a timeslot indication corresponding to a timeslot that has expired, and the second timeslot information comprises a data timeslot indication of at least one node that is used to send service data; and
sending, by the first relay node, a second timeslot assignment message comprising the forwarding information and the second timeslot information.

2. The method according to claim 1, wherein updating the first timeslot information comprises deleting a timeslot indication assigned to the first relay node from the first timeslot information, and the timeslot indication assigned to the first relay node comprises a forwarding timeslot of the first relay node, or a forwarding timeslot and a data timeslot of the first relay node.

3. The method according to claim 1, wherein updating the first timeslot information further comprises adjusting at least one timeslot indication in the first timeslot information that is not deleted, and the adjusting comprises prolonging or shortening a timeslot corresponding to the at least one timeslot indication.

4. The method according to claim 1, wherein forwarding information in the second timeslot assignment message comprises a forwarding indication indicating that the at least one relay node needs to forward the second timeslot assignment message, and the second timeslot information comprises a forwarding timeslot indication assigned to the at least one relay node and used to forward the second timeslot assignment message.

5. The method according to claim 1, wherein timeslots separately indicated by a forwarding timeslot indication and a data timeslot indication of at least one relay node that are comprised in the first timeslot information are adjacent.

6. The method according to claim 1, wherein the first timeslot assignment message and the second timeslot assignment message may be beacon packets defined in the ITU-T G.hn standard or MAP messages defined in the IEEE 1901.1 standard.

7. An access point, comprising:
a transceiver;
at least one processor; and
a memory storing instructions that are executable by the at least one processor, the instructions including instructions to:
receive a first timeslot assignment message sent by an upper-level node, wherein the first timeslot assignment message comprises forwarding information and first timeslot information, wherein the forwarding information comprises a forwarding indication indicating that at least one relay node needs to forward the first timeslot assignment message, and the first timeslot information comprises at least one forwarding timeslot indication assigned to the at least one relay node for forwarding the first timeslot assignment message, and further comprises data timeslot indications assigned to a plurality of nodes and used to send service data, and wherein the plurality of nodes comprise the at least one relay node; and
update the first timeslot information to obtain second timeslot information, wherein updating the first timeslot information comprises deleting an expired timeslot indication from the first timeslot information, the expired timeslot indication is a timeslot indication corresponding to a timeslot that has expired, and the second timeslot information comprises a data timeslot indication of at least one node that is used to send service data; and
wherein the transceiver is configured to send a second timeslot assignment message comprising the forwarding information and the second timeslot information.

8. The access point according to claim 7, wherein the at least one relay node comprises a first relay node, and updating the first timeslot information comprises deleting a timeslot indication assigned to the first relay node from the first timeslot information, and the timeslot indication assigned to the first relay node comprises a forwarding timeslot of the first relay node, or a forwarding timeslot and a data timeslot of the first relay node.

9. The access point according to claim 7, wherein updating the first timeslot information comprises adjusting at least one timeslot indication that is not deleted, and the adjusting comprises prolonging or shortening a timeslot corresponding to the at least one timeslot indication.

10. The access point according to claim 7, wherein forwarding information in the second timeslot assignment message comprises a forwarding indication indicating that the at least one relay node needs to forward the second timeslot assignment message, and the second timeslot information comprises a forwarding timeslot indication assigned to the at least one relay node for forwarding the second timeslot assignment message.

11. The access point according to claim 7, wherein timeslots separately indicated by a forwarding timeslot indication and a data timeslot indication of at least one relay node that are comprised in the first timeslot information are adjacent.

12. The access point according to claim 7, wherein the first relay node adds timeslot indication information of a new node.

13. A system, comprising:
at least one head node, wherein each head node of the at least one head node is directly or indirectly connected to one or more relay nodes; and
a first relay node of the one or more relay nodes, the first relay node comprising:
a transceiver;
at least one processor; and
a memory storing instructions that are executable by the at least one processor, the instructions including instructions to:
receive a first timeslot assignment message sent by an upper-level node, wherein the first timeslot assignment message comprises forwarding information and first timeslot information, the forwarding information comprises a forwarding indication indicating that at least one relay node needs to forward the first timeslot assignment message, and the first timeslot information comprises at least one forwarding timeslot indication assigned to the at least one relay node for forwarding the first timeslot assignment message, and further comprises data timeslot indications assigned to a plurality of nodes and used to send service data, and wherein the plurality of nodes comprise the at least one relay node;
update the first timeslot information to obtain second timeslot information, wherein updating the first timeslot information comprises deleting an expired timeslot indication from the first timeslot information, the expired timeslot indication is a timeslot indication corresponding to a timeslot that has expired, and the second timeslot information comprises a data timeslot indication of at least one node that is used to send service data; and
send, using the transceiver, a second timeslot assignment message comprising the forwarding information and the second timeslot information.

14. The system according to claim 13, wherein updating the first timeslot information comprises deleting a timeslot indication assigned to the first relay node from the first timeslot information, and the timeslot indication assigned to the first relay node comprises a forwarding timeslot of the first relay node, or a forwarding timeslot and a data timeslot of the first relay node.

15. The system according to claim 13, wherein updating the first timeslot information comprises adjusting at least one timeslot indication that is not deleted, and the adjusting comprises prolonging or shortening a timeslot corresponding to the at least one timeslot indication.

16. The system according to claim 13, wherein forwarding information in the second timeslot assignment message comprises a forwarding indication indicating that the at least one relay node needs to forward the second timeslot assignment message, and the second timeslot information comprises a forwarding timeslot indication assigned to the at least one relay node and used to forward the second timeslot assignment message.

17. The system according to claim 13, wherein timeslots separately indicated by a forwarding timeslot indication and a data timeslot indication of at least one relay node that are comprised in the first timeslot information are adjacent.

18. The system according to claim 13, wherein the first relay node adds timeslot indication information of a new node.
